(19) United States
(12) Patent Application Publication
(10) Pub. No.: US 2026/0321529 A1
(43) Pub. Date: Oct. 15, 2026

(54) KEYBOARD DEVICE AND KEY STRUCTURE

(71) Applicant: Chicony Electronics Co., Ltd., New Taipei City (TW)

(72) Inventors: Shin-Chin WENG, New Taipei City (TW); Chih-Ping Lin, New Taipei City (TW); Shih-Yu Hsu, New Taipei City (TW); Liang-Chun Yeh, New Taipei City (TW); Bo-Wei Su, New Taipei City (TW)

(21) Appl. No.: 19/555,242

(22) Filed: Mar. 3, 2026

(30) Foreign Application Priority Data
Apr. 10, 2025 (TW) 114113646

(51) Int. Cl. H01H 13/52; H01H 13/04; H01H 13/70

(52) U.S. Cl. CPC H01H 13/52; H01H 13/04; H01H 13/70

(57) ABSTRACT

A keyboard device includes a key structure. The key structure includes a substrate, a key cap, an elastic member, a first connecting assembly, and a second connecting assembly. The key cap is disposed above the substrate. The key cap has an inner surface facing the substrate. The inner surface includes a first surface region and a second surface region. The first surface region and the second surface region are connected to each other so as to have a connecting edge. The elastic member is disposed between the key cap and the substrate and is adjacent to the connecting edge. The first connecting assembly is located between the first surface region and the substrate. The second connecting assembly is located between the second surface region and the substrate.

### CROSS-REFERENCE TO RELATED APPLICATION

This non-provisional application claims priority under 35 U.S.C. § 119(a) to Patent Application No. 114113646 filed in Taiwan, R.O.C. on Apr. 10, 2025, the entire contents of which are hereby incorporated by reference.

### BACKGROUND

### Technical Field

The instant disclosure relates to an input device, and in particular, to a keyboard device and a key structure.

### Related Art

Keyboard has become an indispensable and common input device in current life. Computer products commonly used in daily life (such as a laptop computer, a desktop computer, or a tablet) or large-sized control or processing devices in industry often use keyboards for operation or text inputting.

For large or long keys in the keyboard, a user usually cannot accurately press a center of the key every time during operation. When the user presses a side edge or a corner of the key, it is easy to fail in uniformly distributing a force on the key. As a result, the key cannot descend smoothly or uniformly, which affects signal generation. Consequently, there are problems of difficulty in user operation, poor operation tactile feel, and the like.

### SUMMARY

In view of the above, in one embodiment, a key structure is provided, including a substrate, a key cap, an elastic member, a first connecting assembly, and a second connecting assembly. The key cap is disposed above the substrate. The key cap has an inner surface facing the substrate. The inner surface includes a first surface region and a second surface region. The first surface region and the second surface region are connected to each other and have a connecting edge. The first surface region has a first side edge opposite to the connecting edge. The second surface region has a second side edge opposite to the connecting edge. The elastic member is disposed between the key cap and the substrate and is adjacent to the connecting edge. The first connecting assembly is located between the first surface region and the substrate. The first connecting assembly includes a first connecting plate and a second connecting plate that are pivotally connected to each other. The first connecting plate includes a first upper assembling side and a first lower assembling side that are opposite to each other. The second connecting plate includes a second upper assembling side and a second lower assembling side that are opposite to each other. The first upper assembling side and the second lower assembling side are adjacent to the connecting edge. The first lower assembling side and the second upper assembling side are adjacent to the first side edge. The second connecting assembly is located between the second surface region and the substrate. The second connecting assembly includes a third connecting plate and a fourth connecting plate that are pivotally connected to each other. The third connecting plate includes a third upper assembling side and a third lower assembling side that are opposite to each other. The fourth connecting plate includes a fourth upper assembling side and a fourth lower assembling side that are opposite to each other. The third upper assembling side and the fourth lower assembling side are adjacent to the connecting edge. The third lower assembling side and the fourth upper assembling side are adjacent to the second side edge. The first upper assembling side of the first connecting plate has a first rotation axis. A portion of the first rotation axis is located within an orthographic projection area of the elastic member.

In another embodiment, a keyboard device is provided, including the above key structure.

As above, according to the key structure of the embodiment of the instant disclosure, the first upper assembling side and the second lower assembling side of the first connecting assembly, as well as the third upper assembling side and the fourth lower assembling side of the second connecting assembly, are adjacent to the connecting edge and the elastic member. The first lower assembling side and the second upper assembling side of the first connecting assembly are adjacent to the first side edge of the key cap, and the third lower assembling side and the fourth upper assembling side of the second connecting assembly are adjacent to the second side edge of the key cap. Moreover, the portion of the first rotation axis of the first upper assembling side of the first connecting plate is located within the orthographic projection area of the elastic member, so that when any part of the key cap (such as a corner or an edge of the key cap) is pressed, a pressure can be transmitted to the elastic member and another part of the key cap through the first connecting assembly and the second connecting assembly. Without additionally providing another balancing rod piece on the key structure, the key cap can uniformly descend to provide stable signal triggering and a good operation tactile feel, thus achieving advantages of saving costs, simplifying an assembling flow, and the like.

### BRIEF DESCRIPTION OF THE DRAWINGS

The disclosure will become more fully understood from the detailed description given herein below for illustration only, and thus not limitative of the disclosure, wherein:

FIG. 1 is a partially planar diagram of an embodiment of a keyboard device of the instant disclosure;

FIG. 2 is a three-dimensional diagram of a first embodiment of a key structure of the instant disclosure;

FIG. 3 is an exploded three-dimensional diagram of a first embodiment of a key structure of the instant disclosure;

FIG. 4 is another exploded three-dimensional diagram of a first embodiment of a key structure of the instant disclosure;

FIG. 5 is a partially exploded three-dimensional diagram of a first embodiment of a key structure of the instant disclosure;

FIG. 6 is a top view of a first embodiment of a key structure of the instant disclosure;

FIG. 7 is a cross-sectional view along line segment 7-7 of FIG. 6;

FIG. 8 is a cross-sectional view of pressing of a first embodiment of a key structure of the instant disclosure;

FIG. 9 is an exploded three-dimensional diagram of a second embodiment of a key structure of the instant disclosure;

FIG. 10 is another exploded three-dimensional diagram of a second embodiment of a key structure of the instant disclosure;

FIG. 11 is a partially exploded three-dimensional diagram of a second embodiment of a key structure of the instant disclosure;

FIG. 12 is a top view of a second embodiment of a key structure of the instant disclosure.

FIG. 13 is a cross-sectional view along line segment 13-13 of FIG. 12;

FIG. 14 is a cross-sectional view of pressing of a second embodiment of a key structure of the instant disclosure;

FIG. 15 is an exploded three-dimensional diagram of a third embodiment of a key structure of the instant disclosure;

FIG. 16 is another exploded three-dimensional diagram of a third embodiment of a key structure of the instant disclosure;

FIG. 17 is a partially exploded three-dimensional diagram of a third embodiment of a key structure of the instant disclosure;

FIG. 18 is a top view of a third embodiment of a key structure of the instant disclosure;

FIG. 19 is a cross-sectional view along line segment 19-19 of FIG. 18; and

FIG. 20 is a cross-sectional view of pressing of a third embodiment of a key structure of the instant disclosure.

### DETAILED DESCRIPTION

It is noted that, the embodiments, the terms “first”, “second”, “third”, and “fourth” are provided to describe different elements, and the these elements are not thus limited by using these terms. Furthermore, for the sake of convenience and clarity in the description, thicknesses or sizes of the elements in the drawings illustrated in an exaggerated, omitted, or general manner are used to help a person skilled in the art with comprehension and reading, and the sizes of the elements are not completely the actual sizes and are not intended to limit any restraint conditions under which the instant disclosure can be implemented and therefore have no technical significance. Any modification to the structures, change to the proportional relationships, or adjustment on the sizes without affecting the effects and the objectives that can be achieved according to the instant disclosure should fall within the scope of the technical content disclosed by the instant disclosure. In all the figures, the same reference numbers refer to identical or similar elements.

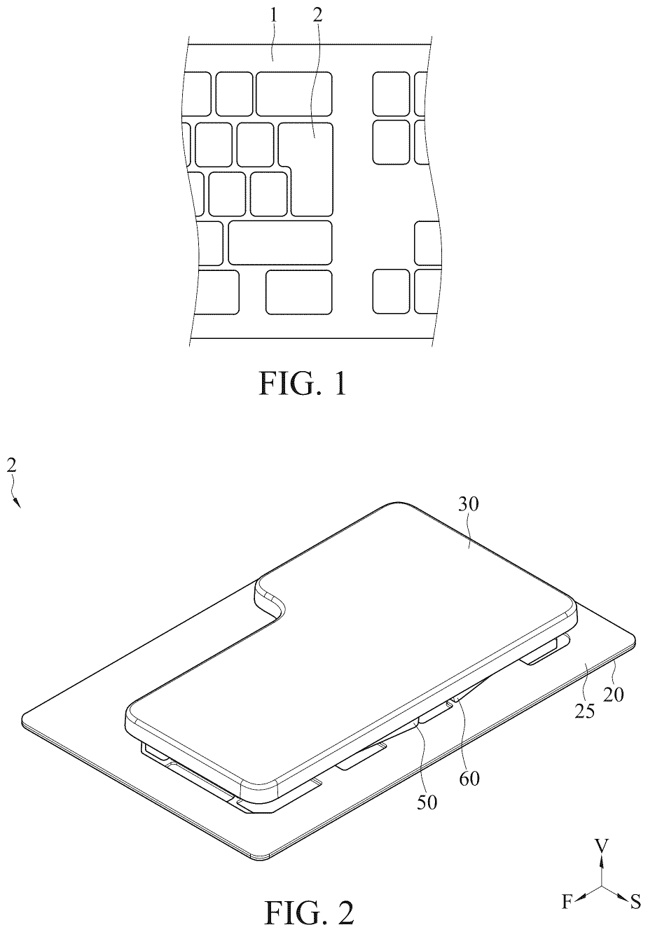

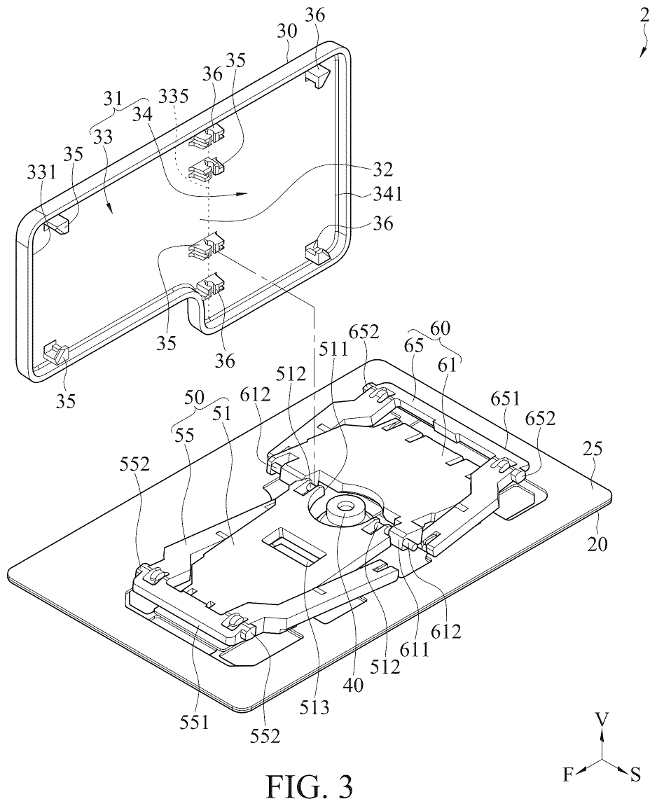

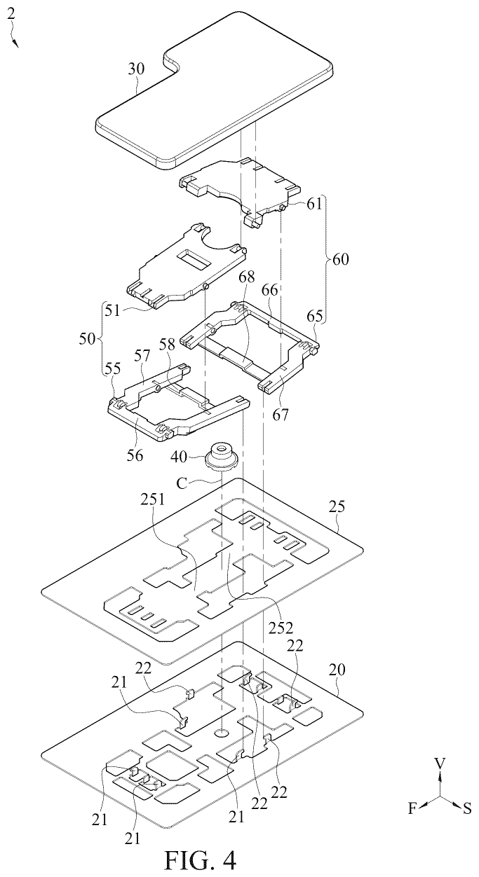

FIG. 1 is a partially planar diagram of an embodiment of a keyboard device of the instant disclosure. FIG. 2 is a three-dimensional diagram of a first embodiment of a key structure of the instant disclosure. FIG. 3 is an exploded three-dimensional diagram of a first embodiment of a key structure of the instant disclosure. FIG. 4 is another exploded three-dimensional diagram of a first embodiment of a key structure of the instant disclosure. As shown in FIG. 1 to FIG. 3, a keyboard device 1 of this embodiment includes a key structure 2. The key structure 2 includes a substrate 20, a key cap 30, an elastic member 40, a first connecting assembly 50, and a second connecting assembly 60. The keyboard device 1 can be an input device for various electronic products (such as a desktop computer, a laptop, or another electronic apparatus). The keyboard device 1 may include a plurality of keys. For example, the plurality of keys may include a plurality of letter keys, a plurality of digit keys, a Space key, an Enter key, and a Caps Lock key.

As shown in FIG. 3 and FIG. 4, the substrate 20 may be a hard plate made of metal (such as aluminum, steel, and alloy) or a plastic material. In this embodiment, a circuit board 25 is stacked on the substrate 20. The circuit board 25 may be a general printed circuit board (PCB), a membrane circuit board, a flexible print circuit board (FPCB), or a rigid-flex PCB.

As shown in FIG. 3 and FIG. 4, one or more key caps 30 may be provided. The key caps 30 are disposed above the substrate 20 and the circuit board 25, and may be pressed by a user to input text, symbols, or instructions. The key cap 30 has an inner surface 31 facing the substrate 20. The inner surface 31 includes a central portion 32, a first surface region 33, and a second surface region 34. The central portion 32 may be a geometric center of the inner surface 31, or the central portion 32 may be a region within a distance (such as 0.1 cm, 0.2 cm, 0.5 cm, or 1 cm) around the geometric center of the inner surface 31. The first surface region 33 and the second surface region 34 are connected to each other and have a connecting edge 335. That is, the connecting edge 335 (as shown in FIG. 3, the connecting edge 335 is represented by the dashed lines) separates the inner surface 31 into the first surface region 33 and the second surface region 34. In this embodiment, the connecting edge 335 is adjacent to the central portion 32. The first surface region 33 has a first side edge 331 opposite to the connecting edge 335, and the second surface region 34 has a second side edge 341 opposite to the connecting edge 335.

As shown in FIG. 3 and FIG. 4, the key cap 30 may be a multiple-width key having a relatively large aspect ratio among a plurality of keys of the keyboard device 1. For example, the key cap 30 may be a Space key, an Enter key, or a Caps Lock key. However, the instant disclosure is not limited to this, and the key cap 30 may be a key with a larger area in the keyboard device 1. For example, a length or width of the first surface region 33 of the key cap 30 may be different from a length or width of the second surface region 34. For example, in this embodiment, the first side edge 331 and the second side edge 341 are parallel to each other and are respectively two opposite side edges of the key cap 30. A length of the second side edge 341 of the second surface region 34 is greater than a length of the first side edge 331 of the first surface region 33, so that the entire key cap 30 is non-quadrilateral (such as non-square or non-rectangular).

As shown in FIG. 3 and FIG. 4, the elastic member 40 is disposed between the key cap 30 and the substrate 20 and is adjacent to the central portion 32 of the inner surface 31 of the key cap 30. For example, the elastic member 40 may be a rubber dome, a metal dome, a plastic dome, a spring, a spring sheet, or another elastomer, and may be in contact with the key cap 30. Thus, when a user presses the key cap 30 to move towards the substrate 20, the key cap 30 can compress the elastic member 40 to store elastic force. When the user releases the key cap 30, the elastic force stored by the elastic member 40 may drive the key cap 30 to move away from the substrate 20 and return to a position at which the key cap 30 is not pressed.

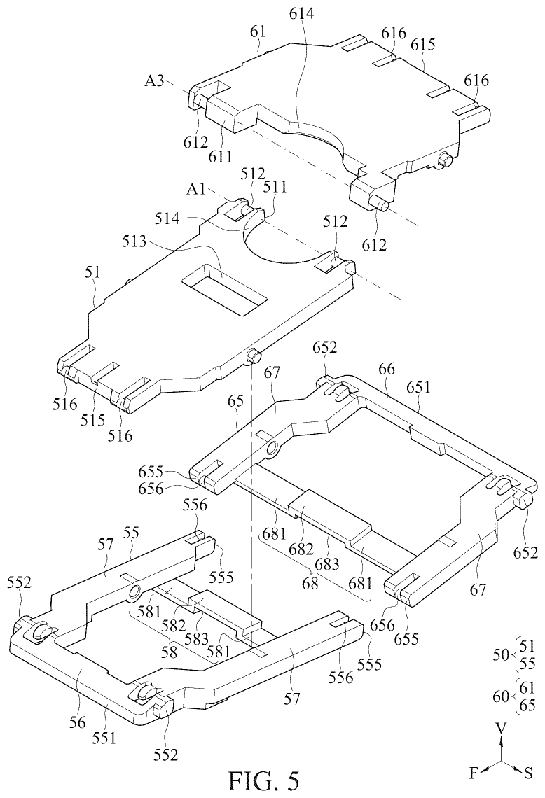

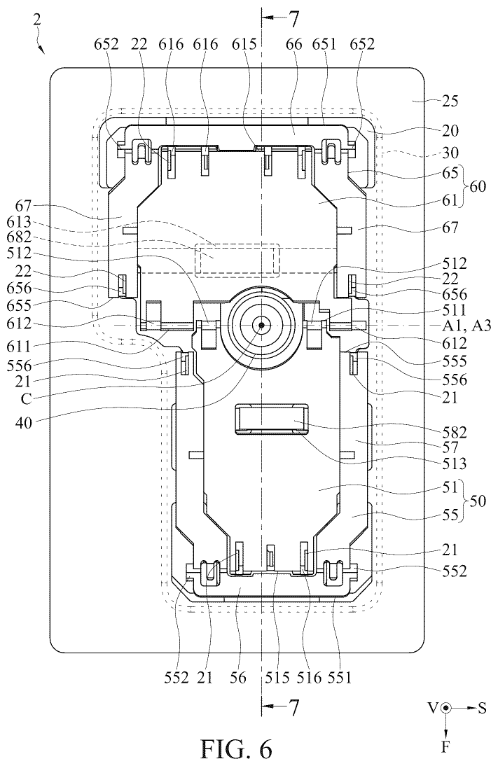

FIG. 5 is a partially exploded three-dimensional diagram of a first embodiment of a key structure of the instant disclosure. FIG. 6 is a top view of a first embodiment of a key structure of the instant disclosure. As shown in FIG. 3 to FIG. 6, the first connecting assembly 50 is located between the first surface region 33 of the key cap 30 and the substrate 20. The first connecting assembly 50 includes a first connecting plate 51 and a second connecting plate 55 that are pivotally connected to each other. In this embodiment, the second connecting plate 55 is a frame-shaped plate and includes a shaft plate 56 and two side arms 57 extending from one side of the shaft plate 56. The two side arms 57 are respectively integrally connected to two opposite ends of the shaft plate 56. The first connecting plate 51 is located between the two side arms 57 of the second connecting plate 55, and two sides of the first connecting plate 51 enclosed by the two side arms 57 are respectively pivotally connected to the two side arms 57, so that the first connecting plate 51 and the second connecting plate 55 intersect each other and are pivotable relative to each other.

As shown in FIG. 3 to FIG. 6, the first connecting plate 51 includes a first upper assembling side 511 and a first lower assembling side 515 that are opposite to each other. The first upper assembling side 511 is rotatably connected to the inner surface 31 of the key cap 30 and is adjacent to the connecting edge 335 and the elastic member 40, while the first lower assembling side 515 is rotatably connected to the substrate 20 and is adjacent to the first side edge 331 of the first surface region 33. The second connecting plate 55 includes a second upper assembling side 551 and a second lower assembling side 555. The second upper assembling side 551 is rotatably connected to the inner surface 31 of the key cap 30 and is adjacent to the first side edge 331 of the first surface region 33. The second lower assembling side 555 is rotatably connected to the substrate 20 and is adjacent to the connecting edge 335 and the elastic member 40.

As shown in FIG. 3 to FIG. 6, the second connecting assembly 60 is located between the second surface region 34 of the key cap 30 and the substrate 20. The second connecting assembly 60 includes a third connecting plate 61 and a fourth connecting plate 65 that are pivotally connected to each other. In this embodiment, the fourth connecting plate 65 is a frame-shaped plate and includes a shaft plate 66 and two side arms 67 extending from one side of the shaft plate 66. The two side arms 67 are respectively integrally connected to two opposite ends of the shaft plate 66 and extend in a direction perpendicular to the shaft plate 66. The third connecting plate 61 is located between the two side arms 67 of the fourth connecting plate 65, and two sides of the third connecting plate 61 enclosed by the two side arms 67 are respectively pivotally connected to the two side arms 67, so that the third connecting plate 61 and the fourth connecting plate 65 intersect each other and are pivotable relative to each other.

As shown in FIG. 3 to FIG. 6, the third connecting plate 61 includes a third upper assembling side 611 and a third lower assembling side 615 that are opposite to each other. The third upper assembling side 611 is rotatably connected to the inner surface 31 of the key cap 30 and is adjacent to the connecting edge 335 and the elastic member 40, while the third lower assembling side 615 is rotatably connected to the substrate 20 and is adjacent to the second side edge 341 of the second surface region 34. The fourth connecting plate 65 includes a fourth upper assembling side 651 and a fourth lower assembling side 655. The fourth upper assembling side 651 is rotatably connected to the inner surface 31 of the key cap 30 and is adjacent to the second side edge 341 of the second surface region 34. The fourth lower assembling side 655 is rotatably connected to the substrate 20 and is adjacent to the connecting edge 335 and the elastic member 40.

As shown in FIG. 3 to FIG. 6, in this embodiment, the substrate 20 is provided with a plurality of first assembling members 21 and a plurality of second assembling members 22 that are spaced apart from each other. The first assembling members 21 and the second assembling members 22 may be clamping hooks that integrally extend upwards from the substrate 20 (for example, the clamping hooks may be L-shaped, U-shaped, or T-shaped). In other embodiments, the first assembling members 21 and the second assembling members 22 may be plastic clamping hooks arranged on the substrate 20. The instant disclosure is not limited to this. The first lower assembling side 515 of the first connecting plate 51 has a plurality of first shaft portions 516. The second lower assembling side 555 of the second connecting plate 55 has a plurality of second shaft portions 556. The third lower assembling side 615 of the third connecting plate 61 has a plurality of third shaft portions 616. The fourth lower assembling side 655 of the fourth connecting plate 65 has a plurality of fourth shaft portions 656. The plurality of first shaft portions 516 and the plurality of second shaft portions 556 are respectively assembled on the plurality of first assembling members 21 of the substrate 20, while the plurality of third shaft portions 616 and the plurality of fourth shaft portions 656 are respectively arranged on the plurality of second assembling members 22 of the substrate 20, so that the first shaft portions 516, the second shaft portions 556, the third shaft portions 616, and the fourth shaft portions 656 can rotate relative to the substrate 20.

As shown in FIG. 3 to FIG. 6, the inner surface 31 of the key cap 30 is provided with a plurality of first connecting portions 35 and a plurality of second connecting portions 36. The first connecting portions 35 and the second connecting portions 36 may be pivot seats or clamping hooks. In this embodiment, four first connecting portions 35 are provided. Some of the first connecting portions 35 (two first connecting portions 35 here) are adjacent to two opposite ends of the first side edge 331 of the first surface region 33 and are close to two corners of the key cap 30. Other first connecting portions 35 (the other two first connecting portions 35 here) are adjacent to the connecting edge 335 and the central portion 32. Four second connecting portions 36 are provided. Some of the second connecting portions 36 (two second connecting portions 36 here) are adjacent to two opposite ends of the second side edge 341 of the second surface region 34 and are close to the other two corners of the key cap 30. Other second connecting portions 36 (the other two second connecting portions 36 here) are adjacent to two opposite ends of the connecting edge 335 and the central portion 32.

As shown in FIG. 3, in this embodiment, the two first connecting portions 35 and the two second connecting portions 36 that are adjacent to the connecting edge 335 are pivot seats with water droplet holes and are coaxial with each other. The two first connecting portions 35 adjacent to the first side edge 331 and the two second connecting portions 36 adjacent to the second side edge 341 are clamping hooks with sliding grooves. In addition, the two first connecting portions 35 adjacent to the first side edge 331 are coaxial with each other, and the two second connecting portions 36 adjacent to the second side edge 341 are coaxial with each other, but it is not limited here. In other embodiments, the first connecting portions 35 and the second connecting portions 36 may respectively use pivot seats with water droplet holes or clamping hooks with sliding grooves. The two first connecting portions 35 and two second connecting portions 36 that are adjacent to the connecting edge 335 may not be coaxial with each other. The two first connecting portions 35 adjacent to the first side edge 331 may not be coaxial with each other. The two second connecting portions 36 adjacent to the second side edge 341 may not be coaxial with each other, depending on actual product requirements.

As shown in FIG. 3, in this embodiment, the two first connecting portions 35 adjacent to the connecting edge 335 are positioned between the two second connecting portions 36 adjacent to the connecting edge 335. However, it is not limited to this. In other embodiments, the two second connecting portions 36 may be positioned between the two first connecting portions 35, or the two first connecting portions 35 and the two second connecting portions 36 may be staggered from each other.

As shown in FIG. 3 to FIG. 5, the first upper assembling side 511 of the first connecting plate 51 is provided with two first rotating shafts 512. The second upper assembling side 551 of the second connecting plate 55 is provided with two second rotating shafts 552. The third upper assembling side 611 of the third connecting plate 61 is provided with two third rotating shafts 612. The fourth upper assembling side 651 of the fourth connecting plate 65 is provided with two fourth rotating shafts 652. The two first rotating shafts 512 and the two second rotating shafts 552 are respectively assembled on the plurality of first connecting portions 35 of the inner surface 31 of the key cap 30, so that the first upper assembling side 511 is arranged along the connecting edge 335 and the two first rotating shafts 512 are respectively adjacent to the two opposite ends of the connecting edge 335, and the second upper assembling side 551 is arranged along the first side edge 331 of the first surface region 33 and the two second rotating shafts 552 are respectively adjacent to the two opposite ends of the first side edge 331. The two third rotating shafts 612 and the two fourth rotating shafts 652 are respectively assembled on the plurality of second connecting portions 36 of the inner surface 31 of the key cap 30, so that the third upper assembling side 611 is arranged along the connecting edge 335 and the two third rotating shafts 612 are respectively adjacent to the two opposite ends of the connecting edge 335, and the fourth upper assembling side 651 is arranged along the second side edge 341 of the second surface region 34 and the two fourth rotating shafts 652 are respectively adjacent to the two opposite ends of the second side edge 341. Thus, the first rotating shafts 512, the second rotating shafts 552, the third rotating shafts 612, and the fourth rotating shafts 652 can rotate relative to the key cap 30. When the key cap 30 is pressed by a user to move toward the substrate 20, the first connecting assembly 50 and the second connecting assembly 60 can rotate and swing relative to the key cap 30 and the substrate 20.

Based on the above, according to the key structure 2 of the embodiment of the instant disclosure, the first upper assembling side 511 and the second lower assembling side 555 of the first connecting assembly 50, as well as the third upper assembling side 611 and the fourth lower assembling side 655 of the second connecting assembly 60, are adjacent to the connecting edge 335 and the elastic member 40. The first lower assembling side 515 and the second upper assembling side 551 of the first connecting assembly 50 are adjacent to the first side edge 331 of the key cap 30, and the third lower assembling side 615 and the fourth upper assembling side 651 of the second connecting assembly 60 are adjacent to the second side edge 341 of the key cap 30, so that when any part of the key cap 30 (such as a corner or an edge of the key cap 30) is pressed, a pressure can be transmitted to the elastic member 40 and another part of the key cap 30 through mutual effective linkage between the first connecting assembly 50 and the second connecting assembly 60. Without additionally providing another balance bar on the key structure 2, the key cap 30 can uniformly descend to provide a stable signal triggering, thus achieving advantages of saving costs, simplifying an assembly process, and the like.

As shown in FIG. 4 and FIG. 5, the first upper assembling side 511 of the first connecting plate 51 of the first connecting assembly 50 may be provided with a first groove 514. The third upper assembling side 611 of the third connecting plate 61 of the second connecting assembly 60 may be provided with a third groove 614. A position of the first groove 514 corresponds to a position of the third groove 614. In this embodiment, the first groove 514 and the third groove 614 are arc-shaped grooves corresponding to the curvature of an edge of the elastic member 40. The elastic member 40 is located within the first groove 514 and the third groove 614, so that the first rotating shafts 512 on the first upper assembling side 511 of the first connecting plate 51 and the third rotating shafts 612 on the third upper assembling side 611 of the third connecting plate 61 are closer to the elastic member 40. This allows the pressure to be transmitted more quickly and stably to the elastic member 40. However, the above embodiments are merely illustrative. In other embodiments, the shapes or dimensions of the first groove 514 and the third groove 614 may vary depending on the type, shape, or size of the elastic member 40. The instant disclosure is not limited thereto.

For example, as shown in FIG. 4 to FIG. 6, in this embodiment, the key structure 2 has a first horizontal direction F, a second horizontal direction S, and a vertical direction V. The first horizontal direction F is perpendicular to the first side edge 331 and the second side edge 341 of the key cap 30. The second horizontal direction S is perpendicular to the first horizontal direction F and is parallel to the first side edge 331 and the second side edge 341 of the key cap 30. The vertical direction V is perpendicular to the substrate 20, the first horizontal direction F, and the second horizontal direction S. In this embodiment, the first rotating shafts 512 of the first connecting plate 51 in the first connecting assembly 50 have a first rotation axis A1, which is parallel to the second horizontal direction S. A portion of the first rotation axis A1 overlaps the elastic member 40 in the vertical direction V. That is, a portion of the first rotation axis A1 of the first upper assembling side 511 of the first connecting plate 51 is located within an orthographic projection area of the elastic member 40. The third rotating shafts 612 of the third connecting plate 61 in the second connecting assembly 60 have a third rotation axis A3. A portion of the third rotation axis A3 also overlaps the elastic member 40 in the vertical direction V. That is, a portion of the third rotation axis A3 of the third upper assembling side 611 of the third connecting plate 61 is located within an orthographic projection area of the elastic member 40. Thus, when the corner or the edge of the key cap 30 is pressed, the pressure can be transmitted more quickly to the elastic member 40 through the linkage of the first connecting assembly 50 or the second connecting assembly 60, thereby improving the response speed of the elastic member 40 to descend under the pressure. This provides more efficient signal input and a better tactile feedback.

As shown in FIG. 4 to FIG. 6, in this embodiment, the bottom of the elastic member 40 is wider than the top, thus forming a narrow upper portion and a wide lower portion. The orthographic projection area of the elastic member 40 can refer to a spatial region defined by projecting an outermost periphery of the bottom of the elastic member 40 onto the inner surface 31 of the key cap 30.

As shown in FIG. 3 to FIG. 6, the elastic member 40 has a central axis C. Preferably, the central axis C passes through a center of the elastic member 40 and is perpendicular to the first rotation axis A1 and the third rotation axis A3. In this embodiment, the first rotation axis A1 of the first rotating shafts 512 of the first connecting plate 51 and the third rotation axis A3 of the third connecting plate 61 are more coaxial with each other, and the first rotation axis A1, the third rotation axis A3, and the central axis C of the elastic member 40 are intersect with one another. Thus, when the corner or the edge of the key cap 30 is pressed, the pressure can be transmitted quickly to a central position of the elastic member 40 through the linkage of the first connecting assembly 50 or the second connecting assembly 60, thereby further improving the response speed of the elastic member 40 to descend under the pressure. In addition, when the first rotation axis A1 and the third rotation axis A3 are coaxial with each other, a width of the second surface region 34 of the key cap 30 in the second horizontal direction S may be 1.2 to 1.5 times a width of the first surface region 33 in the second horizontal direction S.

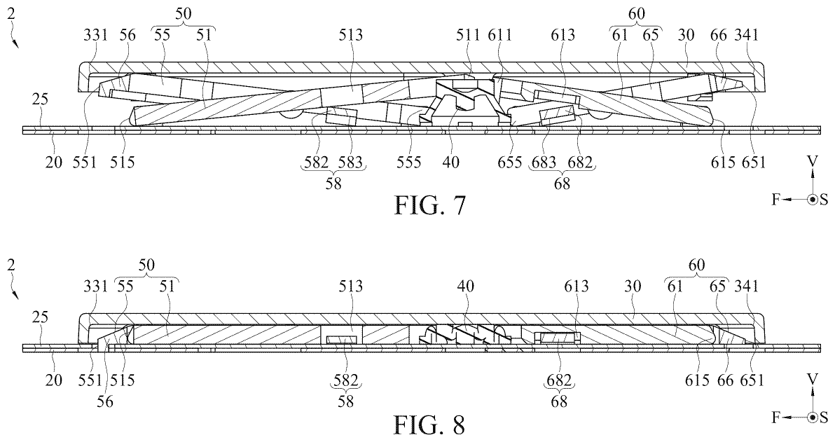

FIG. 7 is a cross-sectional view along line segment 7-7 of FIG. 6. FIG. 8 is a cross-sectional view of pressing of a first embodiment of a key structure of the instant disclosure. As shown in FIG. 7, the second lower assembling side 555 of the second connecting plate 55 is spaced apart from the fourth lower assembling side 655 of the fourth connecting plate 65, and the first upper assembling side 511 of the first connecting plate 51 is located between the second lower assembling side 555 and the fourth lower assembling side 655. In some embodiments, a distance between the first upper assembling side 511 and the second lower assembling side 555 may be equal to or substantially equal to a distance between the first upper assembling side 511 and the fourth lower assembling side 655, so as to maximize the volume of the elastic member 40 and cause the first connecting assembly 50 and the second connecting assembly 60 on the two sides of the elastic member 40 to be uniformly stressed.

As shown in FIG. 5 to FIG. 8, the second connecting plate 55 of the first connecting assembly 50 includes a reinforcing plate 58 on a side opposite to the shaft plate 56. The reinforcing plate 58 is connected between the two side arms 57, so that the second connecting plate 55 in a frame-shaped with improved structural rigidity. Compared with a U-shaped, the frame-shaped structure provides enhanced force transmission efficiency, thereby restricting and guiding a direction of force transmission. The fourth connecting plate 65 of the second connecting assembly 60 includes a reinforcing plate 68 on a side opposite to the shaft plate 66. The reinforcing plate 68 is connected between the two side arms 67, so that the fourth connecting plate 65 in a mouth shape with better structural strength. Compared with a U-shaped, the frame-shaped structure provides enhanced force transmission efficiency, thereby restricting and guiding a direction of force transmission. Furthermore, the arrangement of the reinforcing plate 58 and the reinforcing plate 68 further improves force transmission efficiency of the first connecting assembly 50 and the second connecting assembly 60. Preferably, the reinforcing plate 58 and the reinforcing plate 68 may be integrally connected to the two side arms 57 and 67. The instant disclosure is not limited thereto.

As shown in FIG. 4 to FIG. 8, at least part of a region of the reinforcing plate 58 of the second connecting plate 55 overlaps the first connecting plate 51 in the vertical direction V, and at least part of a region of the reinforcing plate 68 of the fourth connecting plate 65 overlaps the third connecting plate 61 in the vertical direction V. In this embodiment, the reinforcing plate 58 of the second connecting plate 55 includes two horizontal plates 581 and a U-shaped plate 582. The U-shaped plate 582 is connected between the two horizontal plates 581 and has a recess 583. A partial region 251 of the circuit board 25 corresponds to the recess 583. The first connecting plate 51 is provided with a slot 513. A position of the U-shaped plate 582 of the reinforcing plate 58 corresponds to the slot 513. The reinforcing plate 68 of the fourth connecting plate 65 includes two horizontal plates 681 and a U-shaped plate 682. The U-shaped plate 682 is connected between the two horizontal plates 681 and has a recess 683. Another partial region 252 of the circuit board 25 corresponds to the recess 683. The third connecting plate 61 is provided with a slot 613. A position of the U-shaped plate 682 of the reinforcing plate 68 corresponds to the slot 613. In some embodiments, the slot 513 of the first connecting plate 51 and the slot 613 of the third connecting plate 61 may both be through slots or grooves. When the slots 513 and 613 are through slots, the slots 513 and 613 may be used as light-transmitting portions. If the keyboard device 1 is provided with a light emitting member, light emitted by the light emitting member can pass through the slots 513 and 613 to illuminate the key cap 30. Alternatively, the slot 513 of the first connecting plate 51 and the slot 613 of the third connecting plate 61 may be used as alignment slots during assembly. This facilitates automatic assembling of the first connecting assembly 50 and the second connecting assembly 60.

Thus, as shown in FIG. 4 to FIG. 8, when the key cap 30 is pressed by a user to move toward the substrate 20 (as shown in FIG. 8), the U-shaped plate 582 of the reinforcing plate 58 of the second connecting plate 55 and the U-shaped plate 682 of the reinforcing plate 68 of the fourth connecting plate 65 can be respectively located in the slot 513 of the first connecting plate 51 and the slot 613 of the third connecting plate 61, so that the first connecting assembly 50 and the second connecting assembly 60 tends to become substantially flat after being compressed as a whole, thereby reducing a thickness of the keyboard device 1. In addition, after the key cap 30 is pressed, the partial region 251 of the circuit board 25 can be located within the recess 583 of the U-shaped plate 582 of the reinforcing plate 58, and the other partial region 252 of the circuit board 25 can be located within the recess 683 of the U-shaped plate 682 of the reinforcing plate 68. This can enlarge a usage area of the circuit board 25 and provide additional space for circuit layout, and the overall thickness of the keyboard device 1 can be further reduced, thereby achieving a thinner keyboard device 1.

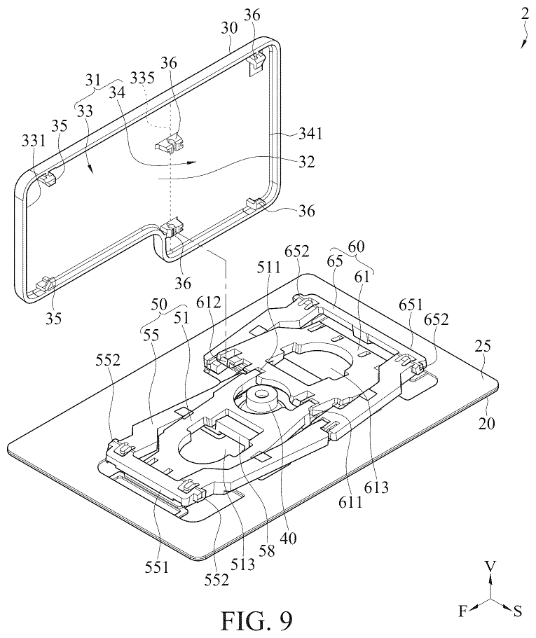

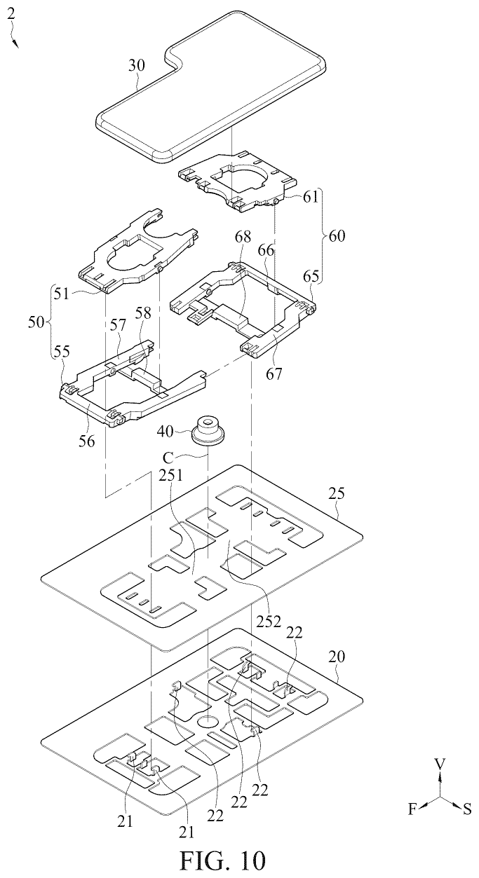

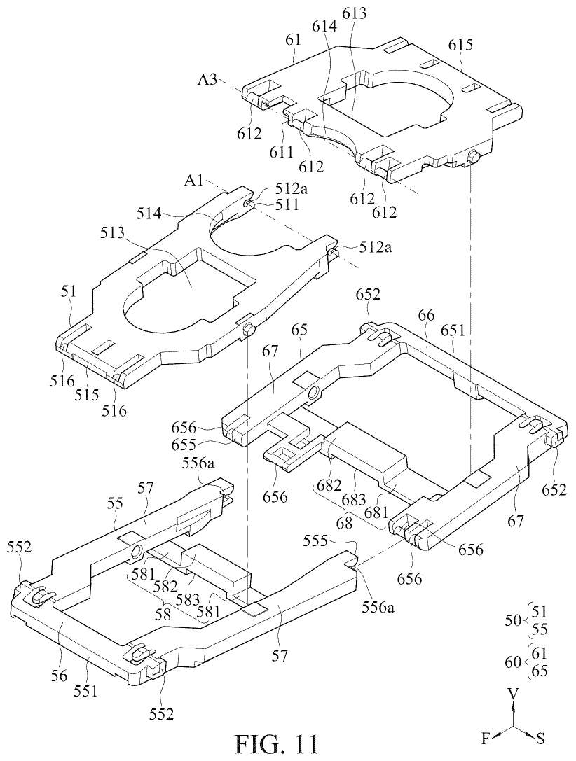

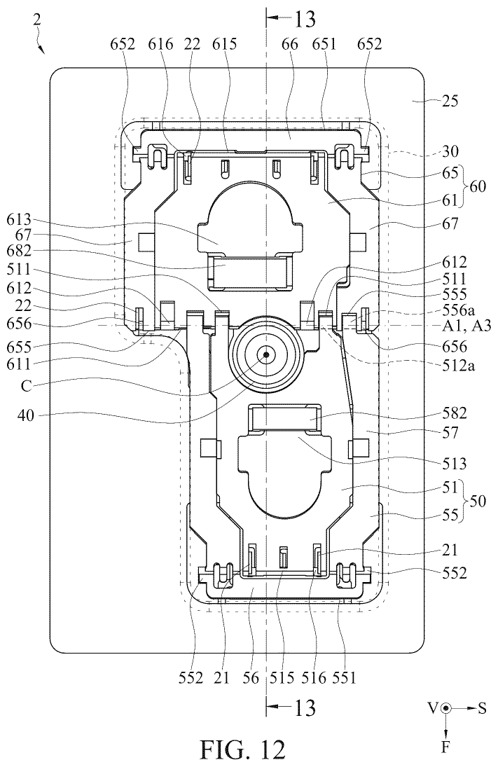

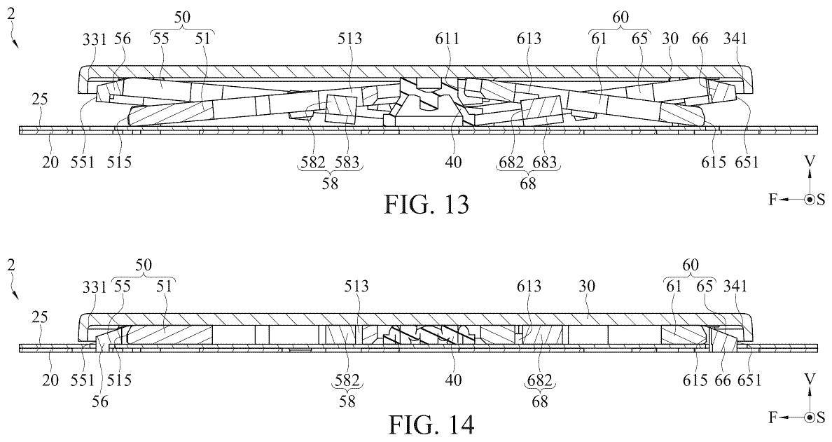

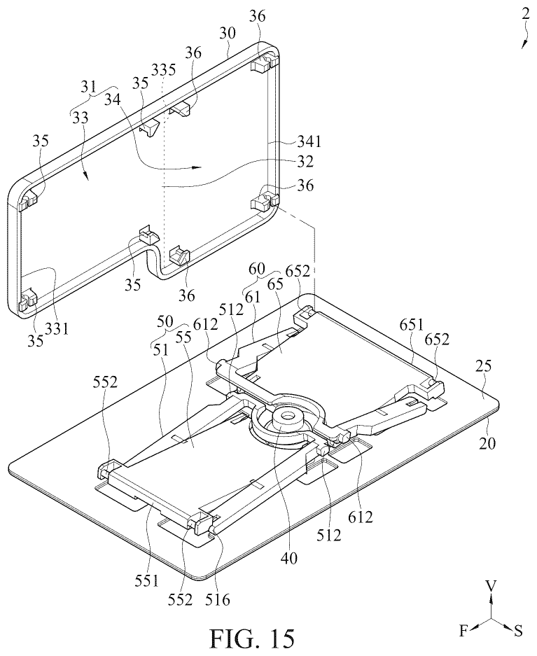

FIG. 9 is an exploded three-dimensional diagram of a second embodiment of a key structure of the instant disclosure. FIG. 10 is another exploded three-dimensional diagram of a second embodiment of a key structure of the instant disclosure. FIG. 11 is a partially exploded three-dimensional diagram of a second embodiment of a key structure of the instant disclosure. FIG. 12 is a top view of a second embodiment of a key structure of the instant disclosure. FIG. 13 is a cross-sectional view along line segment 13-13 of FIG. 12. FIG. 14 is a cross-sectional view of pressing of a second embodiment of a key structure of the instant disclosure. As shown in FIG. 9 to FIG. 14, a difference between this embodiment and the first embodiment is at least that the third upper assembling side 611 of the third connecting plate 61 of the second connecting assembly 60 is provided with four third rotating shafts 612 (as shown in FIG. 11). Two third rotating shafts 612 are coupled to the plurality of second connecting portions 36 on the inner surface 31 of the key cap 30. The first upper assembling side 511 of the first connecting plate 51 of the first connecting assembly 50 is provided with two first pivoting portions 512a (shaft holes here). The two first pivoting portions 512a are respectively pivotally connected on the other two third rotating shafts 612 of the third connecting plate 61 and indirectly connected to the key cap 30, so that the first rotation axis A1 of the first upper assembling side 511 and the third rotation axis A3 of the third upper assembling side 611 are coaxial with each other, and the first connecting plate 51 can rotate and swing relative to the third connecting plate 61 and the key cap 30. Therefore, compared with the first embodiment, this embodiment can reduce the number of connecting portions of the key cap 30 (as shown in FIG. 9, two first connecting portions 35 can be reduced for the key cap 30 in this embodiment), and the first connecting plate 51 and the third connecting plate 61 can be interconnected to improve the force transmission efficiency.

As shown in FIG. 9 to FIG. 14, another difference between this embodiment and the first embodiment is that the fourth lower assembling side 655 of the fourth connecting plate 65 of the second connecting assembly 60 is provided with four fourth shaft portions 656 (as shown in FIG. 11). Two fourth shaft portions 656 are assembled on the second assembling members 22 on the substrate 20, and the second lower assembling side 555 of the second connecting plate 55 of the first connecting assembly 50 is provided with two second pivoting portions 556a (shaft holes here). The two second pivoting portions 556a are respectively pivotally connected to the other two fourth shaft portions 656 of the fourth connecting plate 65 and are coupled to the substrate 20 via the fourth connecting plate 65, so that the second connecting plate 55 is pivotable relative to the fourth connecting plate 65 and the substrate 20. Therefore, compared with the first embodiment, this embodiment can reduce the number of assembling members on the substrate 20 (as shown in FIG. 10, two first assembling members 21 can be reduced for the key cap 30 in this embodiment), and the second connecting plate 55 and the fourth connecting plate 65 are interconnected, thereby improving the force transmission efficiency. In addition, reducing the number of assembling members on the substrate 20 can effectively reduce the number or area of openings in the circuit board 25, enlarging the space available for circuit layout, thereby more effectively utilizing the space of the circuit board 25.

As shown in FIG. 10 to FIG. 12, in this embodiment, the first rotation axis A1 of the first rotating shafts 512a of the first connecting plate 51 and the third rotation axis A3 of the third rotating shafts 612 of the third connecting plate 61 are also coaxial with each other, and the portion of the first rotation axis A1 and the portion of the third rotation axis A3 overlap the elastic member 40 in the vertical direction V. As shown in FIG. 12, another difference between this embodiment and the first embodiment is that the first rotation axis A1 is spaced apart from the central axis C of the elastic member 40 and is not intersected with the central axis C.

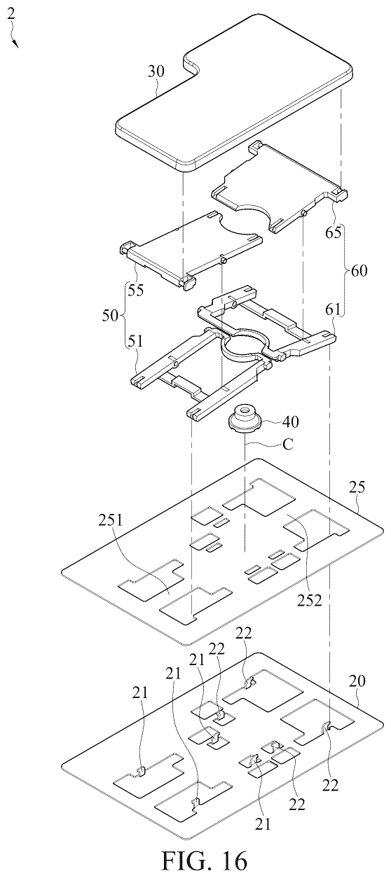

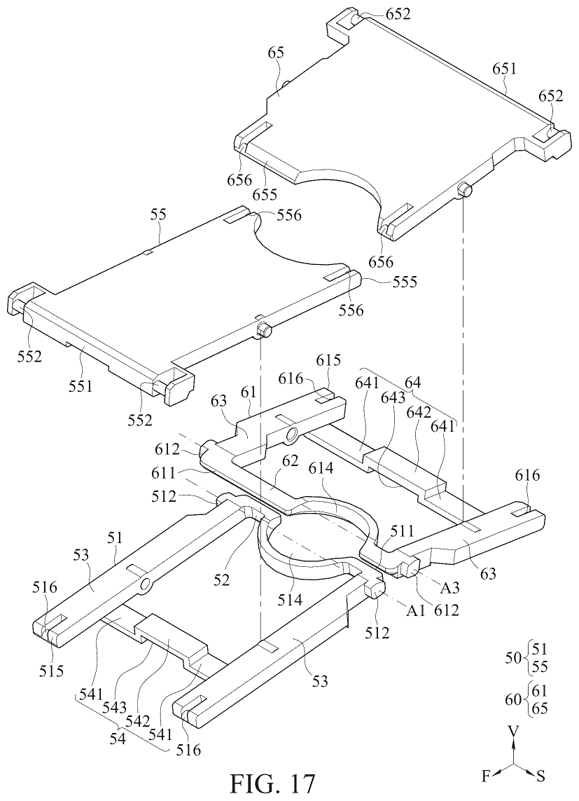

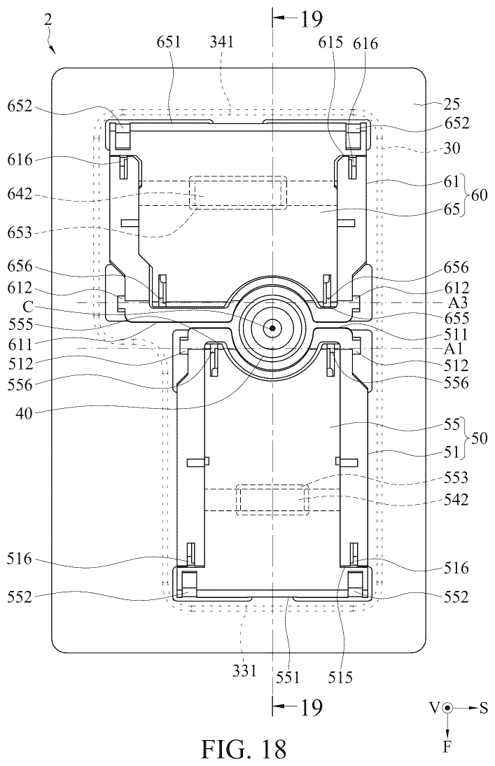

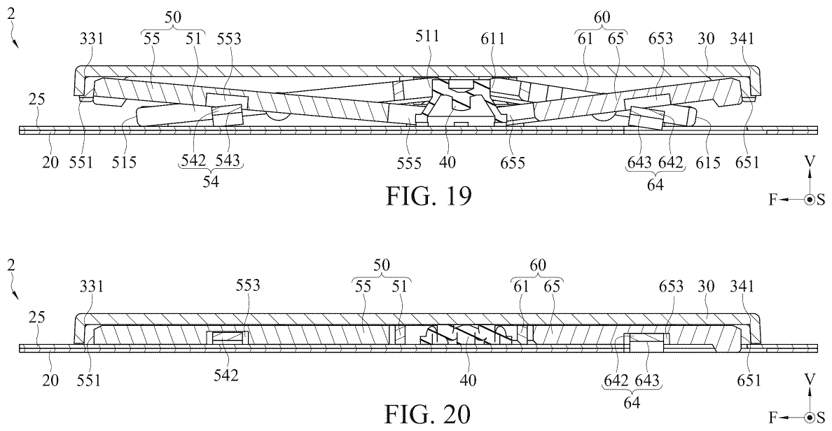

FIG. 15 is an exploded three-dimensional diagram of a third embodiment of a key structure of the instant disclosure. FIG. 16 is another exploded three-dimensional diagram of a third embodiment of a key structure of the instant disclosure. FIG. 17 is a partially exploded three-dimensional diagram of a third embodiment of a key structure of the instant disclosure. FIG. 18 is a top view of a third embodiment of a key structure of the instant disclosure. FIG. 19 is a cross-sectional view along line segment 19-19 of FIG. 18. FIG. 20 is a cross-sectional view of pressing of a third embodiment of a key structure of the instant disclosure. As shown in FIG. 15 to FIG. 20, the first connecting plate 51 and the third connecting plate 61 in this embodiment are frame-shaped plate. The first connecting plate 51 includes a shaft plate 52 and two side arms 53 extending from one side of the shaft plate 52. The second connecting plate 55 is located between the two side arms 53 of the first connecting plate 51, and two sides of the second connecting plate 55 enclosed by the two side arms 53 are respectively pivotally connected to the two side arms 53, so that the first connecting plate 51 and the second connecting plate 55 intersect each other and are pivotable relative to each other. The third connecting plate 61 includes a shaft plate 62 and two side arms 63 extending from one side of the shaft plate 62. The fourth connecting plate 65 is located between the two side arms 63 of the third connecting plate 61, and two sides of the fourth connecting plate 65 enclosed by the two side arms 63 are respectively pivotally connected to the two side arms 63, so that the third connecting plate 61 and the fourth connecting plate 65 intersect each other and are pivotable relative to each other.

As shown in FIG. 15 to FIG. 20, in this embodiment, the first connecting plate 51 includes a reinforcing plate 54 on a side opposite to the shaft plate 52. The reinforcing plate 54 is connected between the two side arms 53. The third connecting plate 61 includes a reinforcing plate 64 on a side opposite to the shaft plate 62. The reinforcing plate 64 is connected between the two side arms 63. The reinforcing plate 54 of the first connecting plate 51 includes two horizontal plates 541 and a U-shaped plate 542. The U-shaped plate 542 is connected between the two horizontal plates 541 and has a recess 543. A partial region 251 of the circuit board 25 corresponds to the recess 543. The second connecting plate 55 is provided with a slot 553 (as shown in FIG. 19). A position of the U-shaped plate 542 of the reinforcing plate 54 corresponds to the slot 553. The reinforcing plate 64 of the third connecting plate 61 includes two horizontal plates 641 and a U-shaped plate 642. The U-shaped plate 642 is connected between the two horizontal plates 641 and has a recess 643. Another partial region 252 of the circuit board 25 corresponds to the recess 643. The fourth connecting plate 65 is provided with a slot 653 (as shown in FIG. 19). A position of the U-shaped plate 642 of the reinforcing plate 64 corresponds to the slot 653.

In addition, as shown in FIG. 15 and FIG. 19, in this embodiment, the two second connecting portions 35 adjacent to the first side edge 331 and the two second connecting portions 36 adjacent to the second side edge 341 are pivot seats with water droplet holes. Therefore, to maximize the structural stability and the force transmission efficiency, in this embodiment, the slot 553 of the second connecting plate 55 and the slot 653 of the fourth connecting plate 65, which are connected to the two first connecting portions 35 and the two second connecting portions 36, are configured in a non-through grooves. This can maximize the retention of the volume of the second connecting plate 55 and the volume of the fourth connecting plate 65 and improve the load-bearing capacity and force transmission efficiency of the second connecting plate 55 and the fourth connecting plate 65.

Thus, as shown in FIG. 16 to FIG. 20, when the key cap 30 is pressed by a user to move toward the substrate 20 (as shown in FIG. 20), the U-shaped plate 542 of the reinforcing plate 54 of the first connecting plate 51 and the U-shaped plate 642 of the reinforcing plate 64 of the third connecting plate 61 can be respectively located in the slot 553 of the second connecting plate 55 and the slot 653 of the fourth connecting plate 65, so that the first connecting assembly 50 and the second connecting assembly 60 tends to become substantially flat after being compressed as a whole, thereby reducing a thickness of the keyboard device 1. In addition, after the key cap 30 is pressed, the partial region 251 of the circuit board 25 can be located within the recess 543 of the U-shaped plate 542 of the reinforcing plate 54, and the other partial region 252 of the circuit board 25 can be located within the recess 643 of the U-shaped plate 642 of the reinforcing plate 64. This can enlarge a usage area of the circuit board 25 and provide additional spaces for circuit layout, and the overall thickness of the keyboard device 1 can be further reduced, thereby achieving a thinner keyboard device 1.

As shown in FIG. 16 to FIG. 18, another difference between this embodiment and the first embodiment is that, in this embodiment, the first rotation axis A1 of the first rotating shafts 512 of the first connecting plate 51 and the third rotation axis A3 of the third rotating shafts 612 of the third connecting plate 61 are spaced apart from each other and are not coaxial with each other. Furthermore, the first rotation axis A1 is spaced apart from central axis C of the elastic member 40 and does not intersect the central axis C, and the third rotation axis A3 is also spaced apart from the central axis C of the elastic member 40 and does not intersect the central axis C A distance between the first rotation axis A1 and the central axis C may be equal to a distance between the third rotation axis A3 and the central axis C (as shown in FIG. 18). A smaller the distance, the higher triggering efficiency when the key cap 30 is pressed, but this is not limited thereto. In some embodiments, either the first rotation axis A1 or the third rotation axis A3 may be intersected with the central axis C of the elastic member 40.

In addition, as shown in FIG. 15 and FIG. 18, when the first rotation axis A1 and the third rotation axis A3 are not coaxial with each other, a width of the second surface region 34 of the key cap 30 in the second horizontal direction S may be 1.1 to 1.5 times a width of the first surface region 33 in the second horizontal direction S. A shortest distance between the second side edge 341 of the key cap 30 and the third rotation axis A3 in the first horizontal direction F may be 0.5 to 0.8 times the shortest distance between the first side edge 331 and the first rotation axis A1 in the first horizontal direction F.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A key structure, comprising:
a substrate;
a key cap disposed above the substrate, wherein the key cap has an inner surface facing the substrate; the inner surface comprises a first surface region and a second surface region; the first surface region and the second surface region are connected to each other and have a connecting edge; the first surface region has a first side edge opposite to the connecting edge; the second surface region has a second side edge opposite to the connecting edge;
an elastic member that is disposed between the key cap and the substrate and is adjacent to the connecting edge;
a first connecting assembly located between the first surface region and the substrate, wherein the first connecting assembly comprises a first connecting plate and a second connecting plate that are pivotally connected to each other; the first connecting plate comprises a first upper assembling side and a first lower assembling side that are opposite to each other;
the second connecting plate comprises a second upper assembling side and a second lower assembling side that are opposite to each other; the first upper assembling side and the second lower assembling side are adjacent to the connecting edge; the first lower assembling side and the second upper assembling side are adjacent to the first side edge; and
a second connecting assembly located between the second surface region and the substrate, wherein the second connecting assembly comprises a third connecting plate and a fourth connecting plate that are pivotally connected to each other; the third connecting plate comprises a third upper assembling side and a third lower assembling side that are opposite to each other; the fourth connecting plate comprises a fourth upper assembling side and a fourth lower assembling side that are opposite to each other; the third upper assembling side and the fourth lower assembling side are adjacent to the connecting edge; the third lower assembling side and the fourth upper assembling side are adjacent to the second side edge, wherein
the first upper assembling side of the first connecting plate has a first rotation axis; and a portion of the first rotation axis is located within an orthographic projection area of the elastic member.

2. The key structure according to claim 1, wherein the third upper assembling side of the third connecting plate has a third rotation axis; and a portion of the third rotation axis is located within an orthographic projection area of the elastic member.

3. The key structure according to claim 2, wherein the first upper assembling side, the second upper assembling side, the third upper assembling side, and the fourth upper assembling side are rotatably connected to the inner surface; the first lower assembling side, the second lower assembling side, the third lower assembling side, and the fourth lower assembling side are rotatably connected to the substrate; and the first rotation axis and the third rotation axis are coaxial with each other.

4. The key structure according to claim 2, wherein the first upper assembling side of the first connecting plate of the first connecting assembly is pivotally connected to the third upper assembling side of the third connecting plate of the second connecting assembly, and the first rotation axis and the third rotation axis are coaxial with each other.

5. The key structure according to claim 2, wherein the first rotation axis and the third rotation axis are non-coaxial.

6. The key structure according to claim 1, wherein the elastic member has a central axis perpendicular to the first rotation axis, and the first rotation axis is intersected with the central axis.

7. The key structure according to claim 1, wherein the second lower assembling side of the second connecting plate of the first connecting assembly is pivotally connected to the fourth lower assembling side of the fourth connecting plate of the second connecting assembly.

8. The key structure according to claim 1, wherein the second lower assembling side of the second connecting plate is spaced apart from the fourth lower assembling side of the fourth connecting plate, and the first upper assembling side of the first connecting plate is located between the second lower assembling side and the fourth lower assembling side.

9. The key structure according to claim 1, wherein the second upper assembling side of the second connecting plate of the first connecting assembly is provided with two second rotating shafts; and the two second rotating shafts are rotatably connected to the inner surface and are respectively adjacent to two opposite ends of the first side edge of the first surface region.

10. The key structure according to claim 1, wherein the fourth upper assembling side of the fourth connecting plate of the second connecting assembly is provided with two fourth rotating shafts; and the two fourth rotating shafts are rotatably connected to the inner surface and are adjacent to two opposite ends of the second side edge of the second surface region.

11. The key structure according to claim 1, wherein the first connecting plate or the second connecting plate of the first connecting assembly comprises a shaft plate, two side arms, and a reinforcing plate; the two side arms extend from one side of the shaft plate; and the reinforcing plate is connected between the two side arms.

12. The key structure according to claim 11, wherein the reinforcing plate comprises two horizontal plates and a U-shaped plate; the U-shaped plate is connected between the two horizontal plates; the U-shaped plate is provided with a recess; the substrate is provided with a circuit board; and a partial region of the circuit board corresponds to the recess.

13. The key structure according to claim 12, wherein the first connecting plate of the first connecting assembly is provided with a slot; the second connecting plate comprises the shaft plate, the two side arms, and the reinforcing plate; and a position of the U-shaped plate of the reinforcing plate corresponds to the slot.

14. The key structure according to claim 12, wherein the second connecting plate of the first connecting assembly is provided with a slot; the first connecting plate comprises the shaft plate, the two side arms, and the reinforcing plate; and a position of the U-shaped plate of the reinforcing plate corresponds to the slot.

15. The key structure according to claim 1, wherein the first upper assembling side of the first connecting plate of the first connecting assembly is provided with a first groove; the third upper assembling side of the third connecting plate of the second connecting assembly is provided with a third groove; a position of the first groove corresponds to a position of the third groove; and the elastic member is located inside the first groove and the third groove.

16. A keyboard device, comprising the key structure according to claim 1.
